(19) United States
(12) Patent Application Publication
(10) Pub. No.: US 2012/0317586 A1
(43) Pub. Date: Dec. 13, 2012

(54) METHODS OF REFERENCE COUNTING ACROSS MULTIPLE PROCESSES

(76) Inventors: Brian Duane Clevenger, Muncie, IN (US); Gilles Thierry Morillon, Melesse (FR)

(21) Appl. No.: 13/315,362

(22) Filed: Dec. 9, 2011

Related U.S. Application Data
(60) Provisional application No. 61/424,919, filed on Dec. 20, 2010.

(51) Int. Cl. G06F 9/46

(52) U.S. Cl. 719/313

(57) ABSTRACT

A method for reference counting across multiple processes in a global counter. The method includes receiving a request to increment a count and add a reference to a reference list, incrementing the count and updating the reference list with the additional reference, receiving a request to decrement the count and remove a different reference from the reference list, and decrementing the count and updating the reference list by removing the difference reference.

### CROSS REFERENCE TO RELATED APPLICATIONS

This application claims the benefit of U.S. provisional application No. 61/424,919 filed Dec. 20, 2010, the contents of which is hereby incorporated by reference herein.

### BACKGROUND

The concept of reference counting is well established in computer applications. Many managed languages like Java or any of Microsoft's .NET languages actually manage reference counts within the language itself and use a garbage collector to destroy objects when the reference count reaches zero. In languages like C++, there are helpers like boost::shared_ptr that wrap pointers in an object to provide similar reference counting functionality. These solutions only address reference counting within a single process.

It is often necessary for a process to create an object that will be shared by multiple functional units in multiple processes. In such a scenario, it may be difficult to know when an object can be safely deleted. However, reference counting across multiple processes is complicated for many reasons.

For example, in a single process implementation, a simple global reference counter may be incremented and decremented directly to maintain a reference count. In a multi-process implementation, there is no direct access to a common reference counter. Instead, Inter-Process Communication (IPC) transactions must be used. Shared memory might also be a possibility, but this is not an option if the processes are located in different execution environments. IPC transactions require significantly more overhead than simply updating a global counter, so any efficient implementation must take care to minimize the number of required IPC transactions.

In a multi-process architecture, it is possible for a single process to be abruptly terminated. In order for other processes to continue functioning properly without leaking resources, it is necessary to provide a mechanism for tracking the references owned by each process so that if a single process is abruptly terminated the reference counts can be updated accordingly.

Moreover, in a multi-process architecture, it is possible for a reference to exist in transit between processes. For example, process A owns the only reference to an object and decides to send a copy of the reference to process B. If process A deletes its reference immediately after sending the copy to process B, no process will own the reference for a short period of time, but a reference will exist in transmit between process A and process B. As a result, it is necessary to account for references in transit or provide a mechanism that will ensure process A will not release its reference until process B has received it.

### SUMMARY

A method and apparatus for reference counting across multiple processes using a global counter. The method includes receiving a request to increment a count and add a reference to a reference list, incrementing the count and updating the reference list with the additional reference, receiving a request to decrement the count and remove a different reference from the reference list, and decrementing the count and updating the reference list by removing the difference reference.

### BRIEF DESCRIPTION OF THE DRAWINGS

A more detailed understanding may be had from the following description, given by way of example in conjunction with the accompanying drawings wherein:

FIG. 1 is an illustrative block diagram with multiple processes and a global counter; and

FIG. 2 is an illustrative flow diagram of a counting method utilizing a global counter.

### DETAILED DESCRIPTION

It is to be understood that the figures and descriptions of embodiments have been simplified to illustrate elements that are relevant for a clear understanding of the invention, while eliminating other elements and steps that are well known in the art and do not facilitate a better understanding of the present invention.

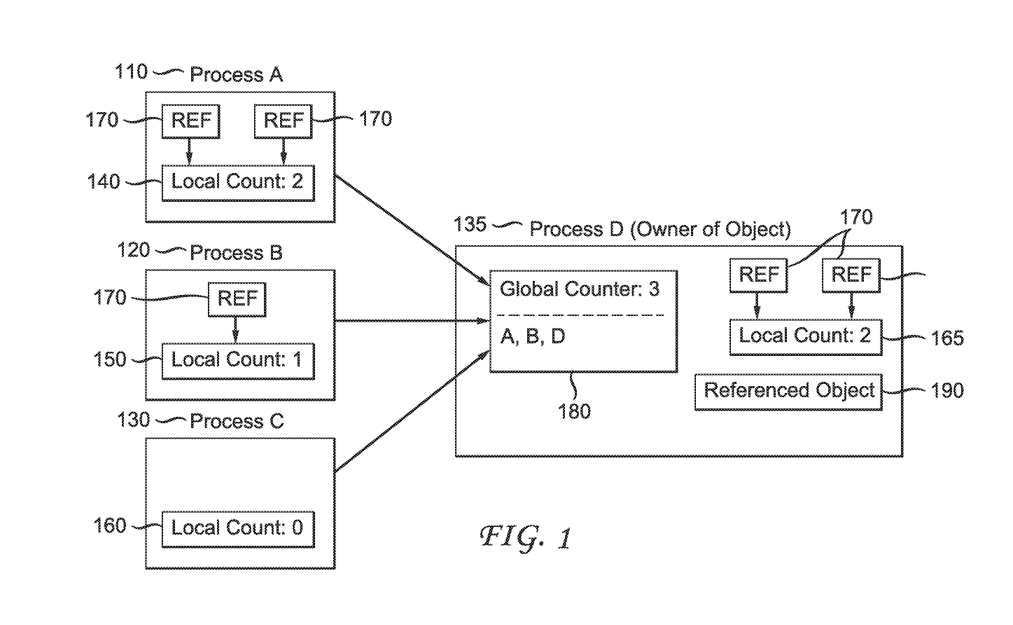

FIG. 1 is an illustrative block diagram with multiple processes and a global counter. FIG. 1 includes Process A 110, Process B 120, Process C 130, and Process D 135. Two levels of reference counting, a local count 160 and a global count 180, may be used to track object references. Each process 110, 120, 130 135 maintains its own local count 140, 150, 160, and 165 of the number of references 170 within the process. The process that owns, or instantiates, the referenced object 190, for example Process D 135 in FIG. 1, also contains a global counter 180. Process D 135 owns the referenced object 190 because Process D 135 instantiated the referenced object 190. The global counter 180 maintains a list of all processes containing at least one reference and a count of the number of processes in the list.

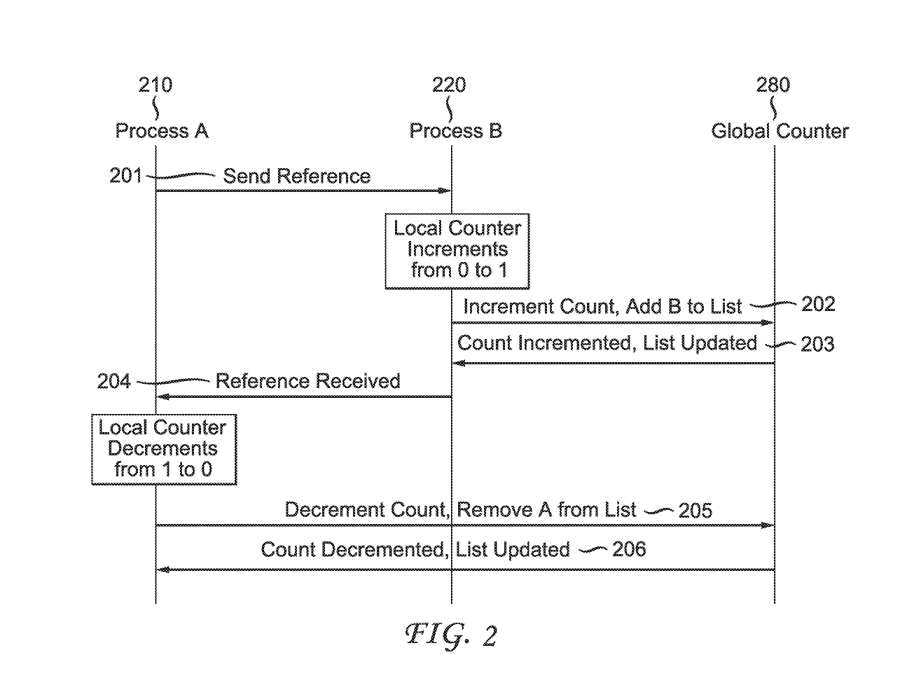

FIG. 2 is an illustrative flow diagram of a counting method utilizing a global counter. Process A 210 transmits a reference 201 to Process B 220. Process B transmits an increment count request and an add process B to reference list request 202 to global counter 280. Global counter 280 transmits a count increment acknowledgement and list updated message 203 to Process B 220. Process B 220 transmits a reference received acknowledgment 204 to Process A 210. Process A 210 transmits decrement count request and remove reference A from reference list request 205 to global counter 280. Global counter 280 transmits a count decremented acknowledgement and list updated message 206 to Process A 210.

The local counters will increment from 0 to 1, when a message is transmitted to add a process to the global list and increment the global counter. When one of the local counters decrement from 1 to 0, a message is transmitted to remove the process from the global list and decrement the global counter. If a process terminates abruptly and the process is in the global process list, the process is removed from the global process list and the global count is decremented.

When the global count reaches 0, there are no processes that own any references to any object present in the process that owns the global counter. The object can be deleted as long as there is no reference in transit between processes. To ensure there is never a reference in transit between processes when no other process owns a copy of the reference, an additional restriction is added. The additional restriction passes shared references between processes with a synchronous transaction. All messages transmitted to update the global reference counter must be synchronous transactions. Synchronous transactions ensure the process sending the reference will not decrement the reference count before the process receiving the reference has incremented the reference count.

While embodiments of the invention have been described, it will be appreciated that modifications of these embodiments are within the true spirit and scope of the invention. The invention is not limited to any particular element(s) that perform(s) any particular function(s) and some may not necessarily occur in the order shown. For example, in some cases two or more method steps may occur in a different order or simultaneously. Although illustrated in the context of separate functional elements, these functional elements may be embodied in one, or more, integrated circuits (ICs). Similarly, although shown as separate elements, any or all of the elements may be implemented in a stored-program-controlled processor, e.g., a digital signal processor, which executes associated software, e.g., corresponding to one, or more, of the functions. These and other variations of the methods disclosed herein will be readily apparent, especially in view of the description of the method described herein, and are considered to be within the full scope of the invention.

1. A method for reference counting across multiple processes in a global counter, the method comprising:
receiving a request to increment a global count and add a process to a global process list;
incrementing the global count and updating the global process list with the additional process;
receiving a request to decrement the global count and remove another process from the global process list; and
decrementing the global count and updating the global process list by removing the another process.

2. The method of claim 1 wherein the receiving the request to add a process to the global process list occurs when a local counter is incremented.

3. The method of claim 1 wherein the receiving a request to remove another process occurs when a local count is decremented.

4. The method of claim 1 further comprising:
removing a process from the global process list and decrementing the global count on a condition that a process abruptly terminates and is listed on the in the global process list.

5. The method of claim 1 further comprising:
deleting the object when the global count reaches zero on the condition that the reference is not between processes.

6. The method of claim 1 wherein the request to increment the global count is a synchronous transaction.

7. The method of claim 1 wherein the request to decrement the global count is a synchronous transaction.

8. A global counter comprising:
a receiver configure to receive a request to increment a global count and add a process to a global process list;
a processor configure to increment the global count and update the global process list with the additional process;
the receiver further configured to receive a request to decrement the global count and remove another process from the global process list; and
the processor further configured to decrement the global count and update the global process list by removing the another process.

9. The global counter of claim 8 wherein the receiving the request to add a process to the global process list occurs when a local counter is incremented.

10. The global counter of claim 8 wherein the receiving a request to remove another process occurs when a local count is decremented.

11. The global counter of claim 8 wherein the processor is further configured to remove a process from the global process list and decrementing the global count on a condition that a process abruptly terminates and is listed on the in the global process list.

12. The global counter of claim 8 wherein the processor is further configured to delete an object (?) when the global count reaches zero on the condition that the reference is not between processes.

13. The global counter of claim 8 wherein the request to increment the global count is a synchronous transaction.

14. The global counter of claim 8 wherein the request to decrement the global count is a synchronous transaction.
